(19) United States
(12) Patent Application Publication
(10) Pub. No.: US 2004/0088435 A1
(43) Pub. Date: May 6, 2004

(54) Data compression by image-forming device server

(76) Inventors: Terrence M. Shannon, Kuna, ID (US); Nolan Letellier, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/285,126

(22) Filed: Oct. 31, 2002

(51) Int. Cl. G06F 15/16

(52) U.S. Cl. 709/247

(57) ABSTRACT

A method of an embodiment of the invention is disclosed that includes sending data from a computing device to an image-forming device server for output by the image-forming device. The image-forming device server compresses the data, and sends the data as compressed data to the image-forming device for output thereby.

### BACKGROUND OF THE INVENTION

Printing data is one of the more common uses of computing devices. A computing device generates the data to be printed, and sends the data directly to a printer, or to a print server which sends the data to the printer, for printing. The printer is more generally referred to herein as an image-forming device. Such image-forming devices can include printers, such as laser and inkjet printers, as well as multi-function devices (MFD's), which can include combination printer and fax machines, combination printer, scanner, and fax machines, and so on.

A computing device usually is unaware of the performance characteristics of printer that it is sending data to for printing, and usually is also unaware of the performance characteristics of the communications link that communicatively couples the printer with the print server or the computing device. This is especially the case where the computing device is a smaller device, such as a personal-digital assistant (PDA) device or a cellular phone, but may also be true where the device is a desktop or laptop computer. The communications link may be a wired or a wireless link, a serial or a parallel connection, and so on.

Because of the typical unawareness of the computing device of the performance characteristics of the printer and/or the communications link, the device may not optimally process the data with the performance characteristics of the printer and/or of the communications link in mind. This can result in slower than desired printing performance, which can be disadvantageous to the user of the computing device.

### SUMMARY OF THE INVENTION

A method of an embodiment of the invention includes sending data from a computing device to an image-forming device server for output by the image-forming device. The image-forming device server compresses the data, and sends the data as compressed data to the image-forming device for output thereby.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of a method, according to an embodiment of the invention.

FIGS. 2, 3, and 4 are diagrams showing three different approaches to distributed data compression, according to varying embodiments of the invention.

FIGS. 5 and 6 are diagrams of systems, according to varying embodiments of the invention.

FIG. 7 is a diagram of an image-forming device server, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

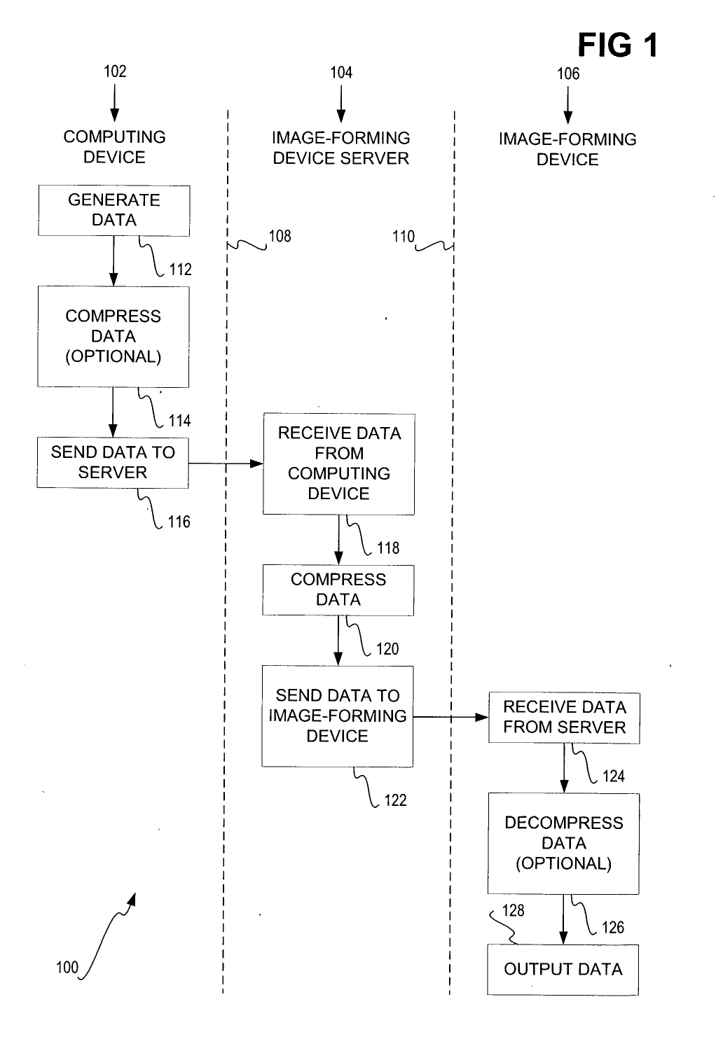

FIG. 1 shows a method 100 according to an embodiment of the invention. Like other methods of embodiments of the invention, at least some parts of the method 100 may be implemented as a computer program of instructions stored on a computer-readable medium, such as a volatile or a non-volatile medium, a fixed or a removable medium, and so on. The parts of the method 100 are performed by a computing device 102, an image-forming device server 104, and an image-forming device 106, as separated by the dotted lines 108 and 110 in FIG. 1.

The computing device 102 generates data to be output by the image-forming device 106 (112). The data may be a document, an image, a combination thereof, or another type of data. For instance, the data may be a word processing file, a web page retrieved from over the Internet, and so on. Furthermore, in one particular embodiment, the data is a raster image of that which is to be output by the image-forming device 106. The computing device 102 may optionally compress the data (114), preferably without being aware of the performance characteristics of the image-forming device 106, as well as of the performance characteristics of the communications link between the image-forming device server 104 and the image-forming device 106. Thus, the compression in 114 is accomplished without adaptation for such performance characteristics, and may not be optimal for the performance characteristics.

The computing device 102 then sends the data, as may have been initially compressed, to the image-forming device server 104 (116), over a communications link, and the data is received by the image-forming device server 104 therefrom (118). The image-forming device server 104 compresses the data (120). Preferably, the image-forming device server 104 is aware of the performance characteristics of the image-forming device 106, and/or of the performance characteristics of the communications link between itself and the image-forming device 106. As a result, the image-forming device server 104 may optimally compress the data based on these performance characteristics.

For instance, the communications link between the server 104 and the image-forming device 106 may be relatively slow, although the image-forming device 106 may itself have relatively fast processing capability. Therefore, the server 104 may compress the data considerably in 120. This is so that the amount of data that has to be sent across the communications link is minimized, and where the image-forming device 106 can quickly decompress the compressed data, where necessary.

As another example, the communications link between the server 104 and the device 106 may be relatively fast, and the image-forming device 106 may itself be relatively fast at outputting data, but have relatively slow processing capability. Therefore, the server 104 may compress the data minimally in 120. Such minimal compression takes advantage of the relatively fast communications link and of the relatively fast output ability of the image-forming device 106, and may not require the device 106 to significantly decompress the data.

The image-forming device server 104 then sends the data, as has been compressed, to the image-forming device 106 (122), over the communications link between the server 104 and the device 106. The communications link between the server 104 and the device 106 may be the same or a different communications link than that which communicatively couples the computing device 102 and the server 104. The image-forming device 106 receives the data (124), optionally decompresses it (126), and outputs the data (128), such as onto media like paper.

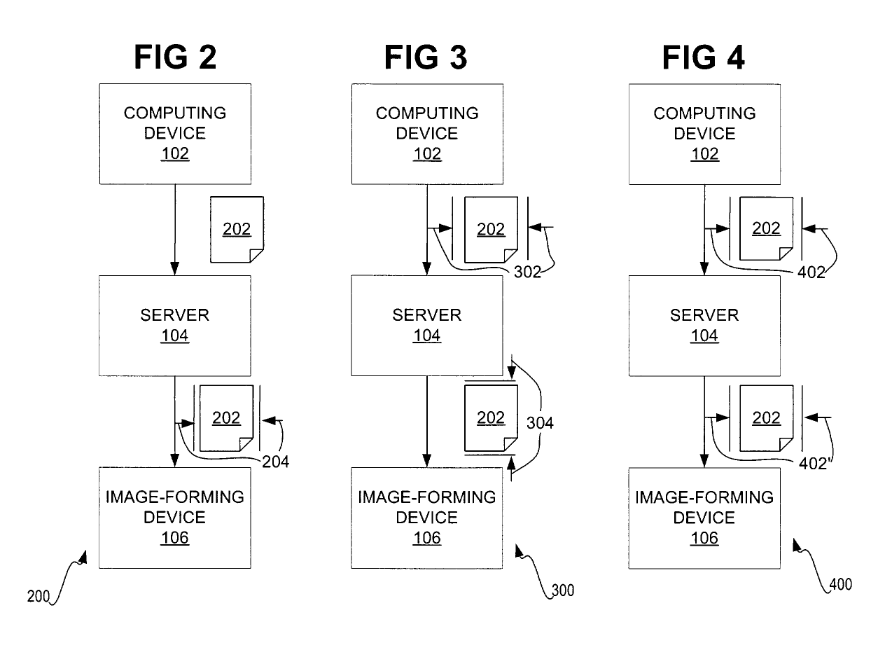

FIGS. 2, 3, and 4 diagrammatically show three different approaches 200, 300, and 400, respectively, to the distributed data compression of the method 100 of FIG. 1, according to varying embodiments of the invention. The data compression of the method 100 is distributed in the sense that the data can be compressed twice. That is, the data may first be compressed by the computing device 102 in 114, and then may be further compressed by the image-forming device server 104 in 120.

In FIG. 2, the compression approach 200 has the computing device 102 sending data 202 to the image-forming device server 104 in an uncompressed manner. That is, the computing device 102 does not compress the data 202. The server 104 in turn does compress the data 202, as indicated by the arrows 204, before sending the data 202 to the image-forming device 106 for output thereby.

The type of compression performed by the server 104, as represented by the arrows 204, is not limited by embodiments of the invention, and may be any type of data compression. Where the data 202 includes images, for instance, the compression may include JPEG-, TIFF-, PNG-, or GIF-related compression, as known within the art. This may entail converting the data 202 from an uncompressed TIF-formatted file, for example, to a compressed TIF-formatted file, or from a GIF-formatted file to a JPEG-formatted file. The compression manners may also include ZIP or PKZIP compression, Huffman coding, LZW coding, ADPCM, PCM, GSM, MPEG, Indeo, Cinepak, as well as other types of compression manners or techniques. The compression may be lossless, where the uncompressed data can be completely extracted from the compressed data, or lossy, where the uncompressed data cannot be completely extracted from the compressed data.

In FIG. 3, the compression approach 300 has the computing device 102 compressing the data 202 before sending it to the image-forming device server 104, as indicated by the arrows 302. The image-forming device server 104 then compresses the data 202 further, as indicated by the arrows 304, before sending the data 202 to the image-forming device 106 for output. The arrows 302 are horizontally depicted in FIG. 3, and the arrows 304 are vertically depicted in FIG. 3, to indicate that the compressions performed by the computing device 102 and the image-forming device server 104 are different. It may be necessary for the image-forming device server 104 to decompress the image prior to compressing it in a different fashion.

For example, the computing device 102 may compress the data 202 by converting it from an uncompressed TIF-formatted file to a compressed TIF-formatted file. The image-forming device server 104 in turn further compresses the data 202, but in accordance with a ZIP or a PKZIP compression manner. Thus, the compression performed by the computing device 102 is different than that performed by the image-forming device server 104. This may allow for greater gains in compression performance, since the two different techniques utilized by the device 102 and the server 104 may complement one another.

In FIG. 4, the compression approach 400 has the computing device 102 compressing the data 202 before sending it to the image-forming device server 104, as indicated by the arrows 402. Similarly, the image-forming device server 104 compresses the data 202 further, as indicated by the arrows 402′, before sending the data 202 to the image-forming device 106 for output. The arrows 402 and 402′ are both horizontally depicted in FIG. 4 to indicate that they are the same type of compression. The computing device 102 performs an initial one or more passes of the compression technique on the data 202, and the image-forming device server 104 performs an additional one or more passes of the same compression technique on the data 202.

For example, the computing device 102 may convert the data 202 from a GIF file to a JPEG file having a certain compression rate, to compress the data 202. The image-forming device server 104 may then more aggressively compress the JPEG file with a greater compression rate, still in accordance with JPEG compression, to further compress the data 202. In this way, both the computing device 102 and the image-forming device server 104 utilize the same compression technique. The image-forming device server 104 may more aggressively compress the data 202, for instance, because it is aware of the performance characteristics of the image-forming device 106, and/or of the communications link between itself and the device 106. Such additional compression is encompassed by the phrase the server 104 performing an additional one or more passes of the compression manner.

As another example, the computing device 102 may initially compress the data 202 for one or more iterations of the compression technique described in the commonly assigned patent application “System and Method for Compressing Data” [attorney docket no. 10012522-1], filed Mar. 28, 2001, and assigned Ser. No. 09/820,494. The image-forming device server 104 may then compress the data 202 for an additional one or more iterations of the same compression technique. The image-forming device server 104 may have, for instance, faster processing capability than the computing device 102. The computing device 102 may thus perform one or two initial iterations of the compression technique, whereas the image-forming device server 104 may perform an additional five or six iterations of the technique to further compress the data.

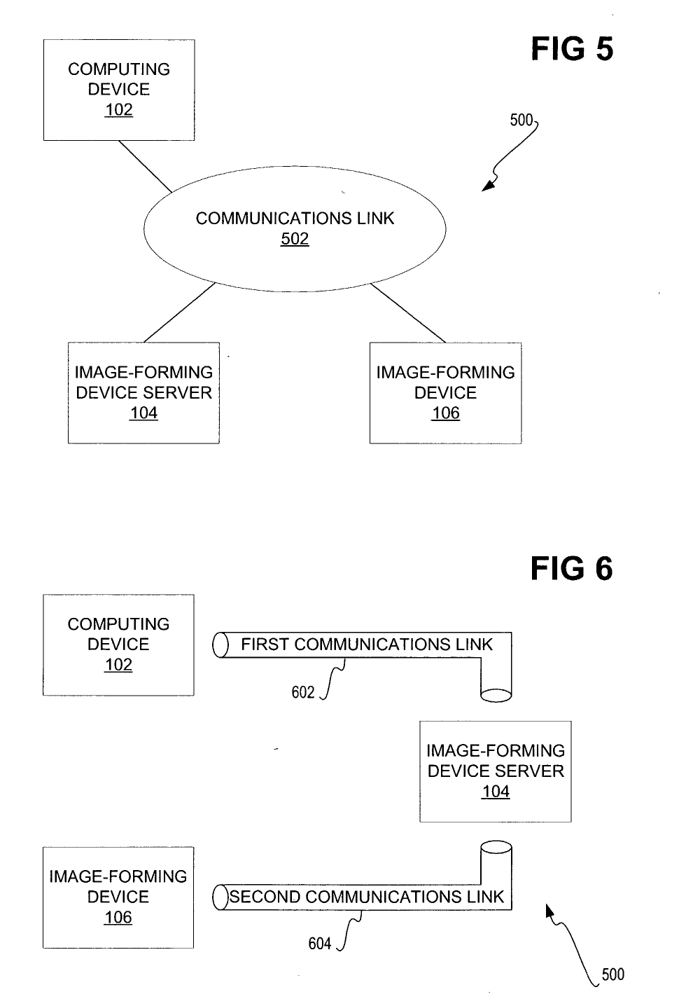

FIGS. 5 and 6 show a system 500 according to varying embodiments of the invention. In both the embodiments of FIGS. 5 and 6, the system 500 includes the computing device 102, the image-forming device server 104, and the image-forming device 106. The computing device 102 may be a personal digital assistant (PDA) device, a wireless or cellular phone, a laptop or a desktop computer, or another type of computing device. The image-forming device server 104 may itself be a laptop or a desktop computer, a specialized server appliance, or may also be another type of computing device. The image-forming device 106 may be a laser printer, an inkjet printer, a multi-function device (MFD), or another type of image-forming device.

The communications link 502 in FIG. 5 and the communications links 602 and 604 in FIG. 6 may each be a number of different types of communications links. For example, each link may be one or more of a local-area network (LAN), a wide-area network (WAN), a wired network, a wireless network, an intranet, an extranet, and the Internet. As another example, each link may be one or more of a serial or a parallel connection, a wired or wireless connection, and so on.

In FIG. 5, the computing device 102, the image-forming device server 104, and the image-forming device 106 are communicatively coupled to a common communications link 502. Thus, the device 102 sends data for output by the device 106 to the server 104 over the link 502, and the server 104 sends the data after compression to the device 106 over the same link 502. By comparison, in FIG. 6, the computing device 102 and the image-forming device server 104 are communicatively coupled to one another via the first communications link 602, and the server 104 and the image-forming device 106 are communicatively coupled to one another via the second communications link 604. The links 602 and 604 in FIG. 6 are thus different communications links.

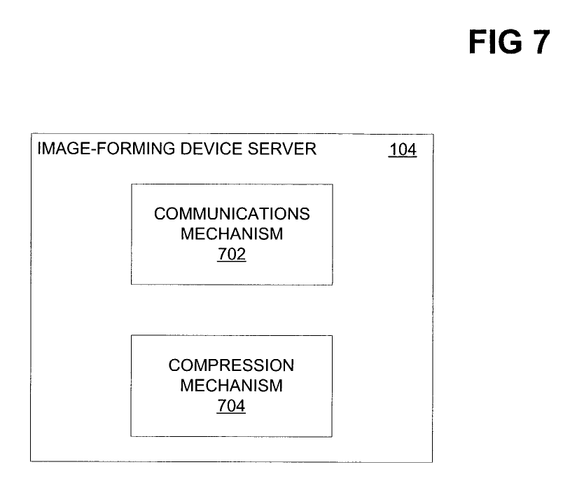

FIG. 7 shows the image-forming device server 104 in more detail, according to a specific embodiment of the invention. The server 104 includes a communications mechanism 702 and a compression mechanism 704, each of which may be considered the means for performing its respective functionality. The communications mechanism 702 enables the server 104 to receive data from the computing device 102 over a communications link, and enables the server 104 to send data to the image-forming device 106 over the same or different communications link. The mechanism 702 may thus include two communications sub-mechanisms in one embodiment, where each sub-mechanism is responsible for communications over a different communications link. The mechanism 702 may be one or more of network adapters, modems, communications ports, and so on, as can be appreciated by those of ordinary skill within the art.

The mechanism 704 enables the server 104 to compress the data received from the computing device 102 prior to sending the data to the image-forming device 106. The mechanism 704 may compress the data for one or more additional passes in accordance with the same compression manner in accordance with which the computing device 102 already has compressed the data. The mechanism 704 may also compress the data in accordance with a different compression manner than the manner in accordance with which the computing device 102 already has compressed the data. The mechanism 704 may finally compress the data where the computing device 102 has not compressed the data. Preferably, the mechanism 704 compresses the data based on the performance characteristics of the image-forming device 106 and/or the communications link between the server 104 and the image-forming device 106. The mechanism 704 may be one or more of computer programs, subroutines of computer instructions, modules of computer instructions, libraries of computer instructions, and so on, as can be appreciated by those of ordinary skill within the art.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

We claim:

1. A method comprising:
sending data from a computing device to an image-forming device server for output by an image-forming device;
compressing the data by the image-forming device server; and,
sending the data as compressed data from the image-forming device server to the image-forming device for output thereby.

2. The method of claim 1, further comprising compressing the data by the computing device.

3. The method of claim 2, wherein the computing device compresses the data in accordance with a first compression manner, and the image-forming device server compresses the data in accordance with a second compression manner.

4. The method of claim 2, wherein the computing device compresses the data for one or more passes in accordance with a compression manner, and the image-forming device server compresses the data for one or more additional passes in accordance with the compression manner.

5. The method of claim 1, further comprising outputting the data by the image-forming device.

6. The method of claim 5, further comprising, prior to outputting the data by the image-forming device, decompressing the compressed data by the image-forming device.

7. The method of claim 1, wherein the image-forming device server compresses the data based on at least one of performance characteristics of the image-forming device and performance characteristics of a communications link over which the image-forming device server sends the compressed data to the image-forming device.

8. The method of claim 1, wherein the computing device is unaware of at least one of performance characteristics of the image-forming device and performance characteristics of a communications link over which the image-forming device server sends the compressed data to the image-forming device.

9. A system comprising:
an image-forming device;
an image-forming device server communicatively coupled to the image-forming device; and,
a computing device communicatively coupled to the image-forming device server, the computing device configured to generate data for output by the image-forming device and to transmit the data to the image-forming device server,
wherein the image-forming device server and the computing device are configured to compress the data.

10. The system of claim 9, further comprising:
a first communications link communicatively coupling the computing device and the image-forming device server; and,
a second communications link communicatively coupling the image-forming device server and the image-forming device.

11. The system of claim 10, wherein the first communications link and the second communications link form a single communications link.

12. The system of claim 10, wherein each of the first communications link and the second communications link comprises one or more of: a wired connection, a wireless connection, a network, a local-area network (LAN), a wide-area network (WAN), an intranet, an extranet, and the Internet.

13. The system of claim 9, wherein each of the image-forming device server and the computing device is configured to compress the data in accordance with a compression manner, such that the computing device is configured to compress the data for one or more initial passes in accordance with the compression manner, and the image-forming device server is configured to compress the data for one or more additional passes in accordance with the compression manner.

14. The system of claim 9, wherein each of the image-forming device server and the computing device is configured to compress the data in accordance with a different compression manner.

15. The system of claim 9, wherein the computing device is configured to compress the data without knowledge of performance characteristics of the image-forming device and without knowledge of performance characteristics of a communications link between the image-forming device server and the image-forming device.

16. The system of claim 9, wherein the image-forming device server is configured to compress the data based on at least one of: performance characteristics of the image-forming device, and performance-characteristics of a communications link between the image-forming device server and the image-forming device.

17. The system of claim 9, wherein the image-forming device server comprises a spooler.

18. The system of claim 9, wherein the computing device is one of: a desktop computer, a laptop computer, a notebook computer, and a personal-digital assistant (PDA).

19. The system of claim 9, wherein the image-forming device one of: a laser printer, an inkjet printer, and a multi-function device (MFD).

20. A computer-readable medium having instructions stored thereon to perform a method for execution by an image-forming device server comprising:
receiving compressed data from a computing device for output by an image-forming device;
compressing the compressed data to yield twice-compressed data; and,
sending the twice-compressed data to the image-forming device for output thereby.

21. The medium of claim 20, wherein the compressed data received has been compressed by one or more initial passes in accordance with a compression manner, and wherein compressing the compressed data comprises compressing the compressed data for one or more additional passes in accordance with the compression manner.

22. The medium of claim 20, wherein the compressed data received has been compressed by the computing device in accordance with a first compression manner, and wherein compressing the compressed data comprises compressing the data in accordance with a second compression manner.

23. The medium of claim 20, wherein receiving the compressed data from the computing device comprises receiving the compressed data over a first communications link, and sending the twice-compressed data to the image-forming device comprises sending the twice-compressed data over a second communications link.

24. The medium of claim 23, wherein the first communications link is different than the second communications link.

25. The medium of claim 20, wherein compressing the compressed data comprises compressing the compressed data based on at least one of: performance characteristics of the image-forming device, and performance characteristics of a communications link between the image-forming device server and the image-forming device.

26. An image-forming device server comprising:
a mechanism to receive data from a computing device and send the data as compressed to an image-forming device; and,
means for compressing the data prior to sending the data to the image-forming device.

27. The server of claim 26, wherein the mechanism receives the data from the computing device as has been compressed thereby for one or more initial passes in accordance with a compression manner, and the means compresses the data for one or more additional passes in accordance with the compression manner.

28. The server of claim 26, wherein the mechanism receives the data from the computing device as has been compressed thereby in accordance with a first compression manner, and the means compresses the data in accordance with a second compression manner.

29. The server of claim 26, wherein the means compresses the data based on at least one of: performance characteristics of the image-forming device, and performance characteristics of a communications link between the image-forming device server and the image-forming device to which the mechanism is communicatively coupled.
